(19) United States
(12) Patent Application Publication
(10) Pub. No.: US 2015/0102917 A1
(43) Pub. Date: Apr. 16, 2015

(54) Driving Device Using Mobile Device and Method for Controlling Same

(71) Applicant: HIROSCI CO., LTD., Daegu (KR)

(72) Inventor: Wonkyu Lee, Daegu (KR)

(73) Assignee: HIROSCI CO., LTD., Daegu (KR)

(21) Appl. No.: 14/401,101

(22) PCT Filed: Sep. 17, 2012
(86) PCT No.: PCT/KR2012/007422

§ 371 Date: Nov. 13, 2014

(30) Foreign Application Priority Data
May 31, 2012 (KR) 10-2012-0058298

(51) Int. Cl. H04Q 9/00; G06F 9/44; A63F 9/24

(52) U.S. Cl. CPC H04Q 9/00; A63F 9/24; G06F 9/44
USPC 340/12.54

(57) ABSTRACT

A driving device using a mobile device and to a method for controlling same, the driving device comprising: an application installed in the mobile device; a wireless communication unit that wirelessly exchanges data with the mobile device; a controller that processes data received through the wireless communication device; a sensor unit that is connected to the controller and transmits information on external conditions to the controller; a drive unit that is connected to the controller and is driven according to a command sent from the application; and a display unit that is connected to the controller and outputs the condition of the sensor unit, the wireless communication unit, and the drive unit to the outside.

### CROSS REFERENCE TO RELATED APPLICATIONS

This application is the U.S. national phase of International Patent Application No. PCT/KR2012/007422 filed Sep. 17, 2012, which claims the benefit of Korean Patent Application No. 10-2012-0058298 filed May 31, 2012, the entire content of which is incorporated herein by reference.

### FIELD OF THE INVENTION

Disclosed herein are driving systems and methods of controlling the driving systems and, more particularly, a driving system using a mobile device which is configured such that a driving apparatus is controlled by an application installed on the mobile device and the maximum performance of the driving apparatus can be adjusted depending on the skill or record of a user in manipulating the driving apparatus, and a method of controlling the driving system.

### BACKGROUND

Generally, driving apparatuses such as toys, vehicles, robots, etc. are controlled by users using wire/wireless controllers provided as accessories of the driving apparatuses and are designed such that the maximum performance of the driving apparatuses can be shown under the control of the users. However, conventional driving apparatuses do not have any expansion system. Therefore, if a beginner handles a driving apparatus having an excessively high level of performance (speed, a high level of difficulty in manipulating), the driving apparatus may be damaged by his/her unskilled manipulation, and the user may easily lose interest because of a difficult manipulation method. In contrast, if the user handles a driving apparatus having an excessively low level of performance, he/she may easily get bored, thus being forced to purchase a different product having a higher level of performance without using the existing driving apparatus anymore.

### SUMMARY

Disclosed herein are a driving system using a mobile device and a method of controlling the driving system which is configured such that the maximum performance of a driving apparatus can be adjusted in stages depending on the skill or experience level of a user in manipulating the driving apparatus, and game elements can be provided to give interest to the user over a long period of time, and a method of controlling the driving apparatus.

In order to accomplish the above object, an embodiment provides a driving system using a mobile device, comprising: a mobile device; an application installed on the mobile device; and a driving apparatus, having a wireless communication unit communicating data with the mobile device by wireless, a control unit processing data received through the wireless communication unit, a sensor unit connected to the control unit, the sensor unit transmitting external conditions to the control unit, a drive unit connected to the control unit, the drive unit being operated according to a command transmitted from the application, and a display unit connected to the control unit, the display unit outputting conditions of the sensor unit, the wireless communication unit, and the drive unit.

The wireless communication unit may use at least one of either Bluetooth communication or wireless LAN (WiFI) communication.

The sensor unit may comprise at least one among an acceleration sensor, a gyro sensor, a luminance sensor, a vibration sensor, a pressure sensor and a temperature sensor.

The display unit may comprise at least one of a speaker, an LED and a small monitor.

The driving apparatus may comprise at least one of a toy, a robot, a vehicle and an airplane.

Another embodiment provides a method of controlling a driving system using a mobile device, the method comprising: a first step of checking whether there is an experience value stored in an application when a driving apparatus is lastly operated; a second step of setting a maximum performance in response to the stored experience value, if the experience value stored in the application is present at the first step; a third step of manipulating the driving apparatus using the application after the second step; a fourth step of analyzing an ability of a user in carrying out a mission of a game element provided from the application or manipulating the driving apparatus after the third step; a fifth step of increasing or reducing the experience value based on a numerical value analyzed at the fourth step; and a sixth step of changing, by the application, the maximum performance in operating the driving apparatus in response to a last experience value calculated at the fifth step, wherein if there is no experience value at the first step, an initial setting value is checked, and the second step is conducted using the initial setting value in lieu of the stored experience value.

The initial setting value may be zero, and the stored value may be stored in the application so that even when another driving apparatus is manipulated, settings and the experience value stored in the application can be used without any change.

In carrying out the mission of the game element at the fourth step, success or failure may be determined according to the degree to which manipulation of the user is similar to a preset correct driving apparatus manipulation method, and wherein a virtual item and an experience value may be provided when the user succeeds in accomplishing the mission.

The user may directly use, within the application, either the virtual item or the experience value provided when succeeding the mission, or the user may give the virtual item or the experience value to another user.

When the virtual item provided when succeeding in accomplishing the mission is activated, a control function corresponding to a function of the virtual item may be activated such that the control function along with other functions is used on the hardware of a toy, thus providing a new function or an advanced function.

In a driving system using a mobile device and a method of controlling the driving system as disclosed herein, the maximum performance of a driving apparatus can be adjusted in stages depending on the skill or experience level of a user in manipulating the driving apparatus, and game elements are provided to give interest to the user over a long period of time. Thereby, there is an advantage of preventing the redundant purchase of products.

### BRIEF DESCRIPTION OF THE DRAWINGS

FIG. 1 is a block diagram showing the construction of a driving system using a mobile device according to an embodiment disclosed herein; and

FIG. 2 is a flowchart showing a method of manufacturing the driving system using the mobile device according to an embodiment disclosed herein.

### DETAILED DESCRIPTION

Hereinafter, a driving system using a mobile device and a method of controlling the driving system will be described in detail with reference to the attached drawings.

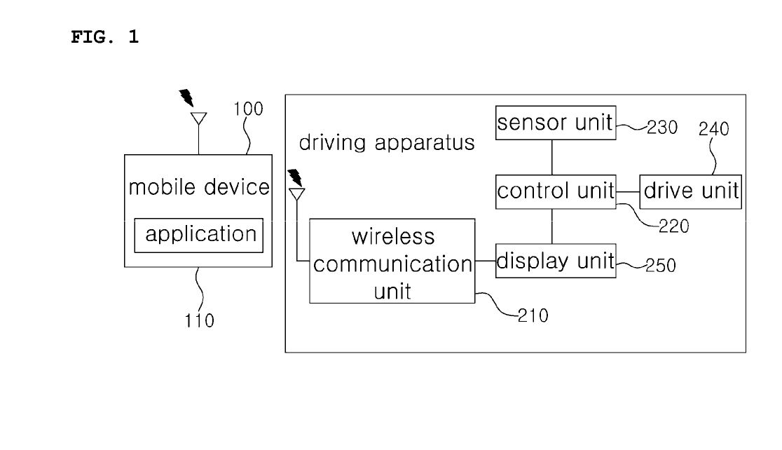

As shown in FIG. 1, the driving system using the mobile device comprises a mobile device 100, an application 110 which is installed on the mobile device 100, and a driving apparatus 200 which is driven by operating the application 110.

The application 110 is installed on the mobile device 100 such as a smart phone or a tablet computer. The application 110 uses a program to control the operation of the driving apparatus 200 and records consequential experience values and manages them.

The data processed by the application 110 is transmitted to the driving apparatus 200 through a communication antenna that is installed in the mobile device 100.

The driving apparatus 200 comprises a wireless communication unit 210, a control unit 220 connected to the wireless communication unit 210, a sensor unit 230 which is connected to the control unit 220, a drive unit 240 which is connected to the control unit 220, and a display unit 250 which is connected to the control unit 220.

The wireless communication unit 210 receives, through the antenna of the mobile device 100, data resulting from the operation of the application 110 or data about changing settings and transmits the data to the control unit 220.

The wireless communication unit 210 uses either Bluetooth communication or wireless LAN (WiFI) communication, corresponding to a communication device which is generally equipped in the mobile device 100, so that even if the mobile device 100 has no separate communication device, communication can be performed.

The control unit 220 processes data transmitted from the wireless communication unit 210 and transmits operation commands to the following elements.

The sensor unit 230 receives a command from the control unit 220, senses information on external conditions and transmits it to the control unit 220.

The sensor unit 230 comprises at least one of an acceleration sensor, a gyro sensor, a luminance sensor, a vibration sensor, a pressure sensor and a temperature sensor and checks operation experience values of the driving apparatus 200 in various ways, thus enhancing the reliability of data.

The drive unit 240 comprises a motor which drives the driving apparatus 200 when receiving a command from the control unit 220.

The display unit 250 is connected to the control unit 220 and outputs conditions of the sensor unit 230, the wireless communication unit 210 and the drive unit 240.

The display unit 250 comprises at least one of a speaker, an LED and a small monitor, and makes it possible for a user through sound, light, a screen, etc. to check current conditions of the driving apparatus 200 or conditions of the operation of the driving apparatus 200 according to a command transmitted from the application 110.

The driving apparatus 200, having the above-mentioned construction, is any one of apparatuses such as a toy, a robot, a vehicle, an airplane, etc. which can be driven by drive force. Even if the kind of driving apparatus 200 is changed, it can be controlled by the application 110.

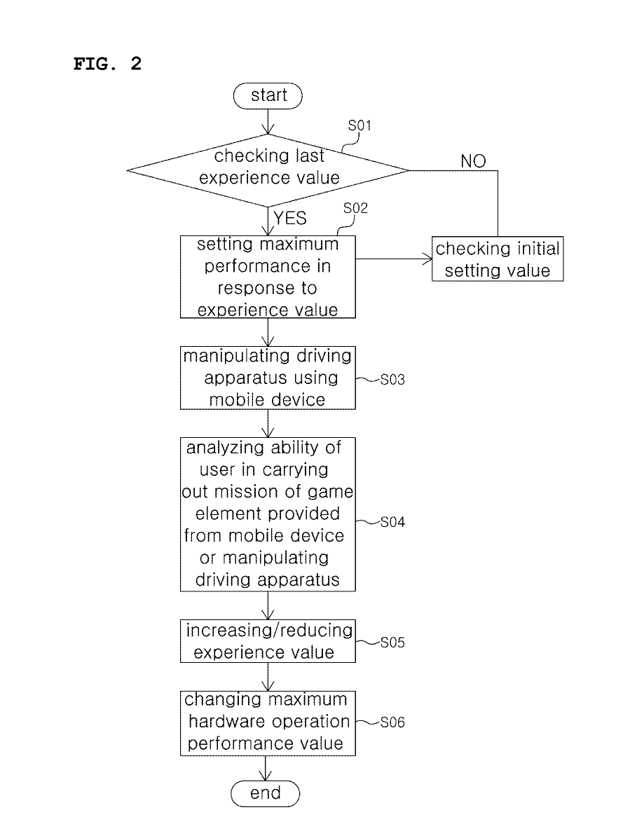

As shown in FIG. 2, the method of controlling the driving apparatus 200 using the mobile device 100 comprises first to sixth steps.

At the first step S01, the application 110 installed on the mobile device 100 checks an experience value, corresponding to the experience level of the user, which has been stored since the driving apparatus 200 was most recently operated.

If at the first step S01 there is no stored experience value, in lieu of the stored experience value, an initial setting value is used to conduct the second step S02. The initial setting value is set as zero, and this can be adjusted depending on a level required by the user.

Furthermore, the experience values are stored in the application 110 so that even when the application 110 operates another apparatus of the same item, its setting and experience values can be used as it is.

This means the following: given the fact that, as stated in the description of the driving apparatus 200, the kind of driving apparatus 200 is not limited only to a toy, the same application 110 can be used to operate various kinds of driving apparatuses 200 so long as they can be driven according to the operation of the application 110 in the same mechanism, whereby even when the kind of driving apparatus 200 is changed, it is possible to share and use the experience values that have been stored in the application 110.

At the second step S02, if there is an experience value at the first step S01, the maximum performance is set in response to the stored experience value.

At the third step S03, the application installed on the mobile device 100 is used to operate the driving apparatus 200 after the second step S02.

At the fourth step S04, while the third step S03 is performed, the ability of the user in carrying out a mission of a game element, provided by the application or by manipulating the driving apparatus, is analyzed.

Carrying out the mission of the game element is made in such a way that when the user accomplishes a mission along a correct manipulation process and completes the mission, a virtual item and an experience value are provided. An online functional element is added such that the user can use the virtual item or experience value that has been provided by completing the mission on the mobile device 100 or give it to anyone else.

At the fifth step S05, the experience value is increased or reduced based on a numerical value analyzed at the fourth step SS04.

At the sixth step S06, a maximum hardware operation performance value is set in response to the most recent experience value calculated at the fifth step S05.

In this way, if the driving apparatus 200 is controlled by the mobile device 100, the maximum performance of the driving apparatus 200 can be adjusted depending on the manipulation ability of the user or the experience value, whereby as the performance of the driving apparatus 200 can be changed in stages depending upon improvement in skill level of the user. As such, because game elements are provided, the user can maintain an interest for a long period of time, thus preventing the redundant purchase of products.

Although the preferred embodiment has been disclosed for illustrative purposes, those skilled in the art will appreciate that various modifications, additions and substitutions are possible, without departing from the scope and spirit of the invention as disclosed in the accompanying claims.

1. A driving system using a mobile device, comprising:
a mobile device;
an application installed on the mobile device; and
a driving apparatus, comprising: a wireless communication unit communicating data with the mobile device by wireless; a control unit processing data received through the wireless communication unit; a sensor unit connected to the control unit, the sensor unit transmitting external conditions to the control unit; a drive unit connected to the control unit, the drive unit being operated according to a command transmitted from the application; and a display unit connected to the control unit, the display unit outputting conditions of the sensor unit, the wireless communication unit, and the drive unit.

2. The driving system of claim 1, wherein the wireless communication unit uses at least one of either Bluetooth communication or wireless LAN (WiFI) communication.

3. The driving system of claim 1, wherein the sensor unit comprises at least one of an acceleration sensor, a gyro sensor, a luminance sensor, a vibration sensor, a pressure sensor and a temperature sensor.

4. The driving system of claim 1, wherein the display unit comprises at least one of a speaker, an LED and a small monitor.

5. The driving system of claim 1, wherein the driving apparatus comprises at least one of a toy, a robot, a vehicle and an airplane.

6. A method of controlling a driving system using a mobile device, the method comprising:
a first step of checking whether there is an experience value stored in an application when a driving apparatus is lastly operated;
a second step of setting a maximum performance in response to the stored experience value, if the experience value stored in the application is present at the first step;
a third step of manipulating the driving apparatus using the application after the second step;
a fourth step of analyzing an ability of a user in carrying out a mission of a game element provided from the application or manipulating the driving apparatus after the third step;
a fifth step of increasing or reducing the experience value based on a numerical value analyzed at the fourth step; and
a sixth step of changing, by the application, the maximum performance in operating the driving apparatus in response to a last experience value calculated at the fifth step, wherein if there is no experience value at the first step, an initial setting value is checked, and the second step is conducted using the initial setting value in lieu of the stored experience value.

7. The method of claim 6, wherein the initial setting value is zero, and the stored value is stored in the application so that even when another driving apparatus is manipulated, settings and the experience value stored in the application can be used without any change.

8. The method of claim 6, wherein in carrying out the mission of the game element at the fourth step, success or failure is determined according to the degree to which manipulation of the user is similar to a preset correct driving apparatus manipulation method, and wherein a virtual item and an experience value are provided when the user succeeds in accomplishing the mission.

9. The method of claim 8, wherein the user directly uses, within the application, either the virtual item or the experience value provided when succeeding the mission; or wherein the user gives the virtual item or the experience value to another user.

10. The method of claim 8, wherein when the virtual item provided when succeeding in accomplishing the mission is activated, a control function corresponding to a function of the virtual item is activated such that the control function along with other functions is used on a hardware of a toy, thus providing a new function or an advanced function.
